(19) United States
(12) Patent Application Publication
(10) Pub. No.: US 2024/0082894 A1
(43) Pub. Date: Mar. 14, 2024

(54) Cleaning Apparatus for Descaling Sterilizing Machines

(71) Applicant: Miguel A. Morales, West Reading, PA (US)

(72) Inventor: Miguel A. Morales, West Reading, PA (US)

(21) Appl. No.: 18/118,584

(22) Filed: Mar. 7, 2023

Related U.S. Application Data
(60) Provisional application No. 63/406,519, filed on Sep. 14, 2022.

(51) Int. Cl. B08B 9/093; B05B 3/02

(52) U.S. Cl. CPC B08B 9/0933; B05B 3/025; B08B 2209/08; B08B 2220/00

(57) ABSTRACT

A cleaning apparatus having a door assembly sealable against the door opening of the sterilizing machine by an inflatable seal connected to an air chuck on the cleaning apparatus is operable to descale a sterilizing machine. The cleaning apparatus includes separate tanks for storing and dispensing cleaning fluid and rinse fluid. A pump associated with each tank sends fluid into the spray wand for distribution within the sterilizer machine. A vacuum is created within the corresponding tank and to draw fluid from the sterilizer machine back into the selected tank. The spray wand can be moved linearly and rotationally to direct the fluid throughout the interior of the sterilizing machine with the fluid being recycled back into the tank through a vacuum port. A selector valve on the cleaning apparatus allows the selection of cleaning fluid or rinse fluid to be drawn into the sterilizing machine.

### CROSS-REFERENCE TO RELATED APPLICATIONS

This application claims domestic priority on co-pending U.S. Provisional Patent Application Ser. No. 63/406,519, filed on Sep. 14, 2022, the content of which is incorporated herein by reference.

### FIELD OF THE INVENTION

This invention relates generally to a portable device for attachment to devices that have fluid passing through them and occasionally need to be cleaned and descaled and, more particularly, to a cleaning cart assembly for cleaning and descaling sterilizing machines.

### BACKGROUND OF THE INVENTION

Sterilizing devices generally use steam operated at pressure with a temperature in the range of 130 degrees F. to sterilize implements, such as surgical devices or dental devices. This process results in a baking of residue, such as packaging materials on the devices and other debris, on the walls of the sterilizer. These residues can interfere with the efficient operation of the sterilizer or could dislodge from the walls of the sterilizer during the sterilizing process to contaminate the devices being sterilized. Cleaning the sterilizer periodically is needed to remove this baked on debris, which is difficult to remove.

One mechanical process that can be used to remove this baked on debris is to use a manually operated grinding/polishing wheel with an abrasive compound for removing the baked on residue. Such manual devices are usually powered by an air compressor. The sterilizer is tented to contain dust generated in the process and breathing equipment is worn by the technician performing the cleaning. This process may damage joints, studs and the walls of the sterilizer.

Another manual mechanical process for descaling the chamber walls is to blast a stream of glass beads under air pressure from an air compressor, which is connected through a long conduit to power the equipment. The chamber is usually tented to contain the beads and dust generated. A ventilation hood, supplied by a separate air compressor, is worn by the operating technician. The surface of the chamber walls is often left in a roughened condition which is difficult to polish to a smooth finish.

In U.S. Pat. No. 3,593,728, granted on Jul. 21, 1970, to Paul Sauer, a cleaning apparatus is disclosed as being useful in cleaning frying, broiling and defrosting chambers. The Sauer apparatus includes dual tanks containing a wash liquid and a rinse liquid, respectively, which is pumped into an elongated nozzle for spraying internally of the chamber being cleaned. The nozzle can be fixed or mounted for rotation in a detachable lid secured to the chamber. The spent liquid is removed from the chamber by a drain formed in the detachable lid and returned to the tank from which the liquid had been pumped.

U.S. Pat. No. 6,341,612, granted on Jan. 29, 2002; U. S. Pat. No. 6,5,487, granted on Apr. 2, 2003; and U.S. Pat. No. 6,562,145, granted on May 13, 2003, all of which are issued to Michael A. Duckett, et al, discloses a cleaning apparatus for sterilizers. The Duckett apparatus is mounted on a mobile cart and includes dual tanks containing wash and rinse liquids that are pumped through a detachable lid clamped to the sterilizer to cover an opening therein. The apparatus draws a vacuum on the lid to seal against the rim of the opening. A spray wand is affixed to the inside face of the lid and hoses are connected between the spray wand and the apparatus to convey under pressure one or more wash liquids and an optional rinse liquid that is sprayed around the interior of the sterilizer to remove the baked on residue and descale the sterilizer. A drain in the lid returns the fluids inserted into the chamber back to the tank from which the fluid was drawn, utilizing valves to select between tanks.

It would be desirable to provide a portable cleaning apparatus that is operable to descale the interior surface of a sterilizing device, or other devices utilizing a flow of fluids and leaving a residue within, in an effective and efficient manner.

### SUMMARY OF THE INVENTION

It is an object of this invention to overcome the disadvantages of the known prior art devices by providing a cleaning apparatus for descaling sterilizing machines.

It is another object of this invention to provide a cleaning apparatus that will mechanize the operation of descaling sterilization machines.

It is a feature of this invention that the cleaning apparatus is equipped with two tanks to contain a supply of cleaning fluid and a supply of rinse fluid, respectively.

It is another feature of this invention that the apparatus also includes a door assembly that engages the door opening of the sterilizing machine.

It is an advantage of this invention that the sealing of the door assembly against the door opening of the sterilizing machine allows the application of a vacuum to the sterilizing machine.

It is another advantage of this invention that a fluid pump draws fluid from a selected tank and directs the flow of fluid into the wash wand associated with the door assembly to spray the fluid throughout the interior of the sterilizing machine.

It is another advantage of this invention that the application of a vacuum to the sterilizing machine creates a flow of fluids from the sterilizing machine into the cleaning apparatus.

It is still another feature of this invention that a selector valve can be manipulated to direct a flow of fluid from a selected tank into the sterilizing machine.

It is yet another feature of this invention that the cleaning apparatus includes an air compressor and a high pressure air chuck that can be used to dry the interior of the sterilizing machine.

It is still another object of this invention to provide a door assembly that is operable to be sealed against the housing of the sterilizing machine defining the door opening for the sterilizing machine.

It is a further feature of this invention that the door assembly includes a wash wand supported by a wand slider collar to permit movement linearly into and out of the door assembly and also rotationally relative to the door assembly.

It is still a further feature of this invention that the distal end of the spray wand, located internally of the sterilizing machine when the door assembly is secured thereto, includes a rotating spray ball.

It is still another advantage of this invention that the movement of the wash wand relative to the door assembly enables the output of the spray wand to reach the entire interior of the sterilizing machine.

It is still another feature of this invention that the door assembly includes an inflatable seal that is connected to a low pressure air chuck on the cleaning apparatus to inflate the seal and secure the door assembly to the sterilizing machine.

It is another object of this invention to provide a method of descaling a sterilizing machine.

It is a feature of this this invention to pump fluid from a selected tank of fluid into a sterilizer machine and to create a vacuum in the sterilizing machine to draw the fluid therein back into the selected tank of the cleaning apparatus.

It is an advantage of this invention that the vacuum is possible due to the sealing of a door assembly against the door opening of the sterilizing machine.

It is another feature of this invention that the flow of fluid to the sterilizing machine from the cleaning apparatus can be selected between a tank containing cleaning fluid and a tank containing rinse fluid.

It is still a further object of this invention to provide a cleaning apparatus operable to descale a sterilizing machine that is durable in construction and simple and effective in use.

These and other objects, features and advantages are accomplished according to the instant invention by providing a cleaning apparatus having a door assembly sealable against the door opening of the sterilizing machine by an inflatable seal connected to an air chuck on the cleaning apparatus in order to descale a sterilizing machine or other sealable device. The cleaning apparatus includes separate tanks for storing and dispensing cleaning fluid and rinse fluid. A pump associated with each tank sends fluid into the spray wand for distribution within the sterilizer machine. A vacuum is created within the corresponding tank and to draw fluid from the sterilizer machine back into the selected tank. The spray wand can be moved linearly and rotationally to direct the fluid throughout the interior of the sterilizing machine with the fluid being recycled back into the tank through a vacuum port. A selector valve on the cleaning apparatus allows the selection of cleaning fluid or rinse fluid to be drawn into the sterilizing machine.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a perspective view of a cleaning apparatus incorporating the principles of the instant invention;

FIG. 1A is a perspective view of the cleaning apparatus of FIG. 1 but having the upper shelf removed for clarity;

FIG. 2 is a schematic cross-sectional view taken along lines 2-2 of FIG. 5 to show the internal structure of the cleaning apparatus;

FIG. 3 is a left side elevational view of the cleaning apparatus shown in FIG. 1;

FIG. 4 is a right side elevational view of the cleaning apparatus shown in FIG. 1;

FIG. 5 is a rear elevational view of the cleaning apparatus of FIG. 1;

FIG. 6 is a front elevational view of a representative door assembly attached to the apparatus, such as a sterilizer, to be descaled through operation of the cleaning apparatus shown in FIG. 1; and

FIG. 7 is a cross-section view taken along lines A-A in FIG. 6.

### DETAILED DESCRIPTION OF THE PREFERRED EMBODIMENTS

Referring now to the drawings, the details of the present invention, relating to the cleaning or descaling of devices having fluids circulated therethrough, such as sterilizers, can best be seen. In the example of medical sterilizers, the use of the sterilizer cleans and sterilizes the medical instruments placed therein, but in this process, residue can be baked on the interior of the walls of the sterilizer and require periodic cleansing and descaling. The cleansing and descaling process of the instant invention utilizes a chemical wash liquid that descales the interior of the sterilizer chamber, following which is a rinsing of the interior of the sterilizer chamber to remove any residue of the chemical wash liquid and return the sterilizer into an operative condition. Any reference to left, right, front or back are used as a matter of convenience and are determined by the location of the control panel, as described in greater detail below, being at the front end of the apparatus.

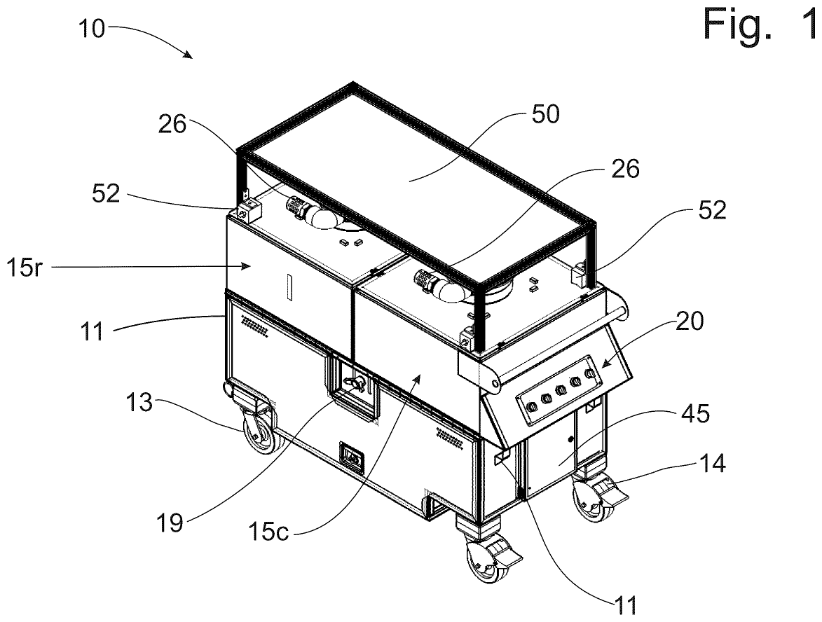

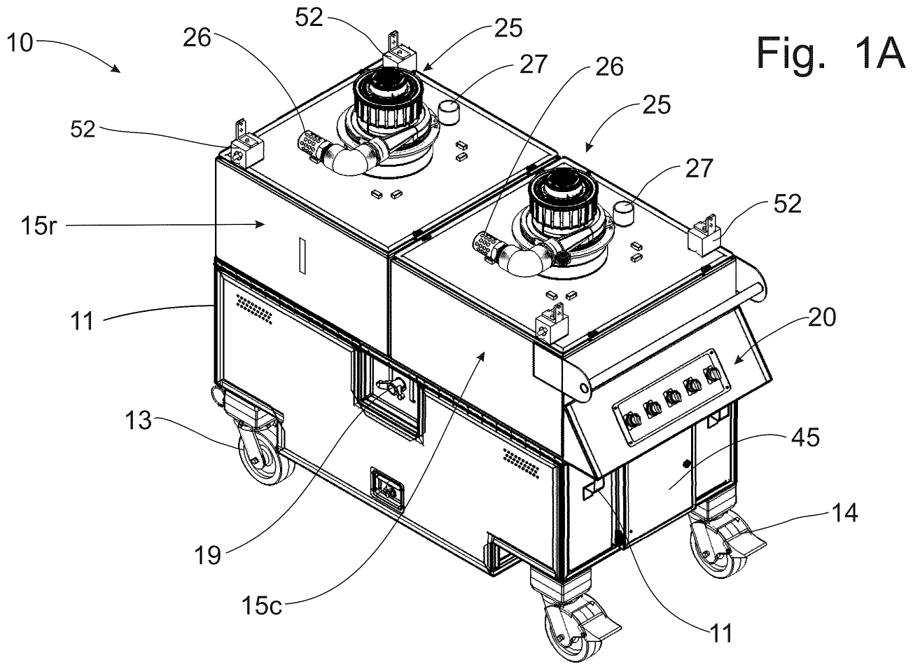

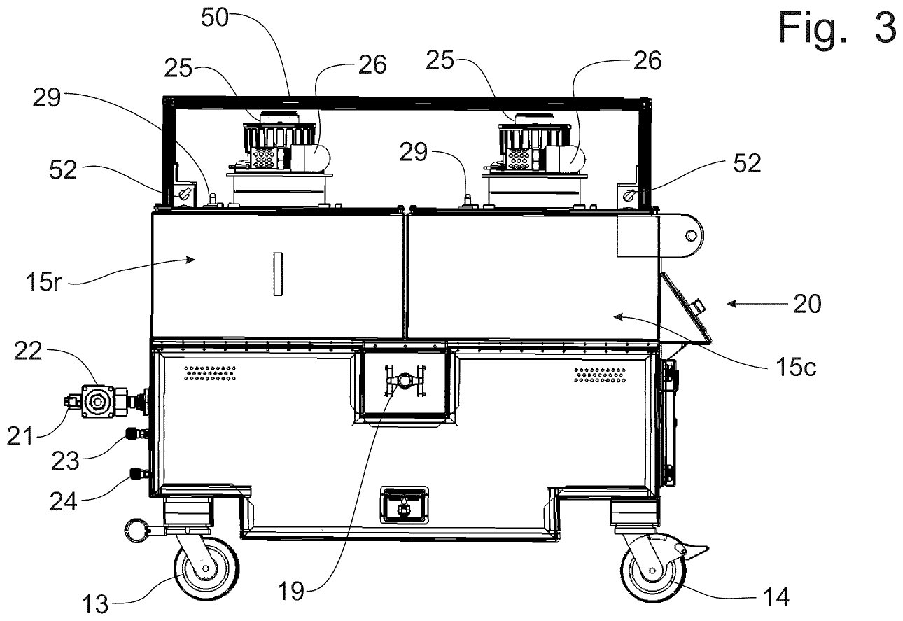

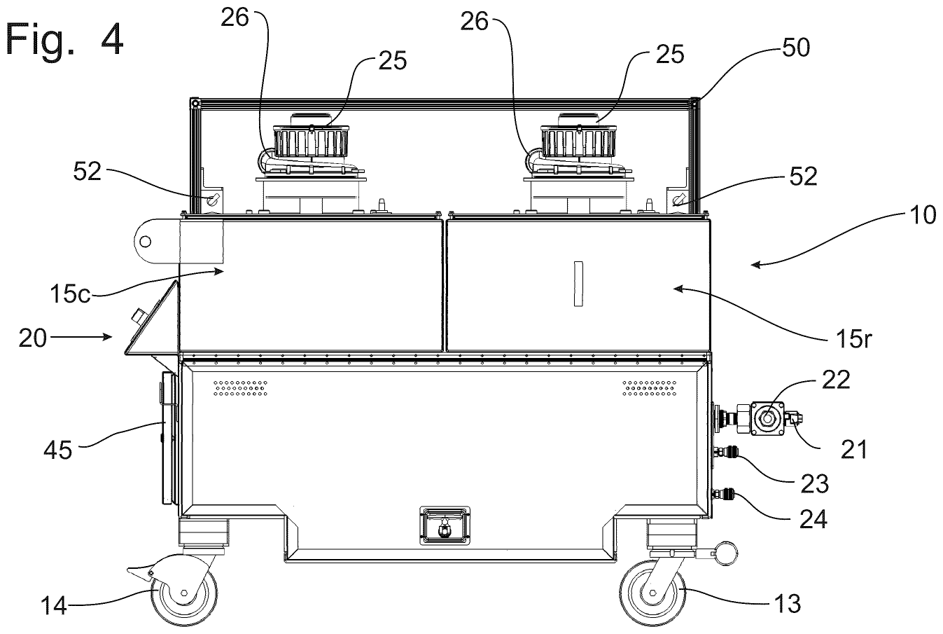

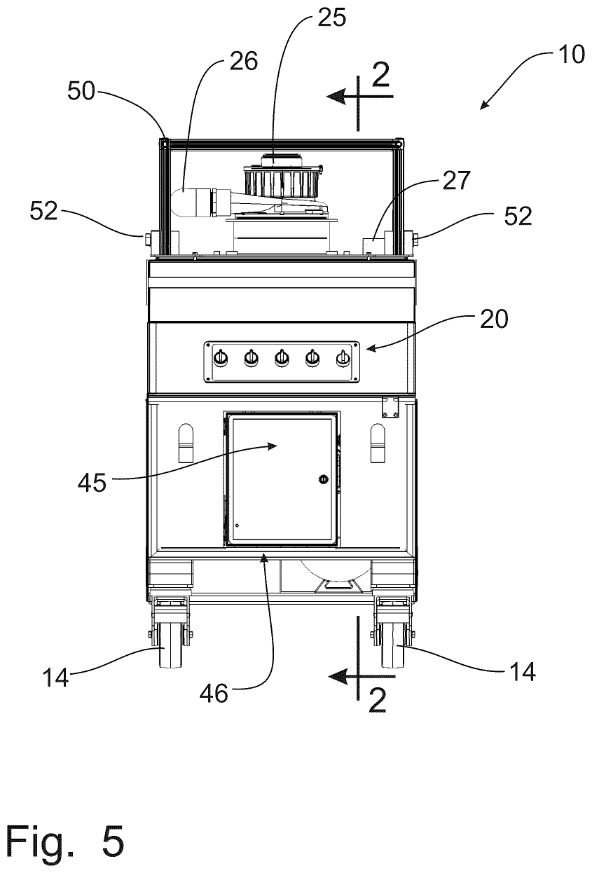

As is shown in FIGS. 1-5 of the drawings, a portable cleaning apparatus 10 is disclosed. The cleaning apparatus 10 includes a washing unit 12 and a door assembly 30. The washing unit 12 has a frame 11 supported on a pair of castor wheels 13 at the rear of the frame 11 and a pair of braked swivel caster wheels 14 at the front of the frame 11. The frame 11 supports two tanks 15c, 15r, oriented in a longitudinal manner to hold supplies of a chemical wash liquid and a rinse liquid, respectively. Underneath the tanks 15c, 15r, the operative components of the cleaning apparatus 10 are located in the lower chamber 16. One skilled in the art will recognize that most of the conduits or lines required for the operation of the washing unit 12, as described in greater detail below, are not shown for purposes of clarity.

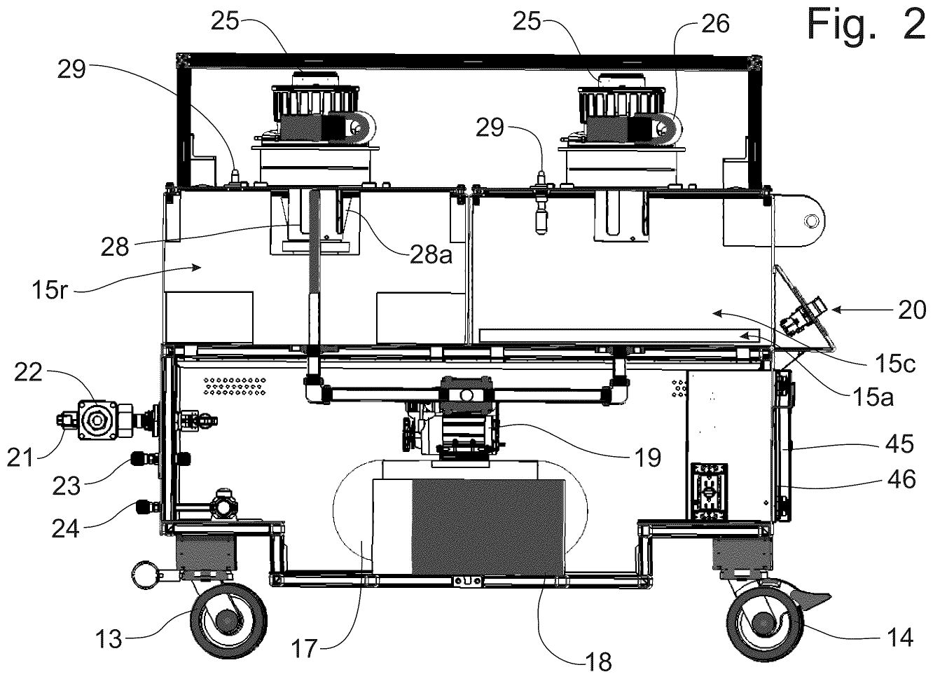

The lower chamber 16 houses an air compressor 17 and a fluid pump 18, schematically depicted in FIG. 2. Also located in the lower chamber 16 is a tank selector valve 19 that is manually operable to draw fluid from either of the tanks 15, as desired by the operator. The tank selector valve 19 is connected by an appropriate conduit (not shown) to a fluid output line 21 having a two-sided ball valve 22 that can be manually turned to direct fluid from the tank selector valve 19 to either the sterilizer (not shown) or to drain the tank from which the tank selector valve 19 is drawing fluid. Beneath the fluid output line 21 are positioned a high pressure air chuck 23 and a low pressure air chuck 24, both of which are operatively connected to the air compressor 17 to provide a flow of air under pressure for purposes to be described in greater detail below. A control panel 20 is supported at the front end of the washing unit 12 to power in a selective manner the operating components of the washing unit 12.

Both tanks 15c, 15r are constructed to include a vacuum motor 25, having a muffler 26, that draws air out of the tank to create a negative pressure in the respective tank 15c, 15r, being used. A vacuum port 27 is provided on the top of each tank 15c, 15r. The vacuum port 27 is open to the interior of the respective tank 15c, 15r, so that the negative pressure or vacuum created by the vacuum motor 25 is applicable to the vacuum port 27. Externally, the vacuum port 27 is connected to a door assembly 30, as will be described in greater detail below. Each tank 15c, 15r, is also provided with a ball float shutoff mechanism 28 that shuts off the vacuum motor 25 if the fluid level in the corresponding tank 15c, 15r, gets too high, such that the vacuum motor 25 might be drawing fluid from the tank 15c, 15r, rather than air. Accordingly, a tank fluid level indicator 29 is provided for each tank 15c, 15r. Optional filter baskets 28a can filter out any contaminates returned to the tanks 15c, 15r containing the chemical wash or rinse fluid, respectively, to prevent any contaminates from being recycled to the sterilizer. The chemical fluid tank 15c is also provided with a heating unit 15a to heat the chemical wash fluid therein.

The cleaning apparatus 10 is preferably formed with an optional shelf 50 overlying the two vacuum pumps 25. The shelf 50 is detachable in that the shelf 50 is connected to the top surface of the fluid tanks 15c and 15r by clamps or an assembly 52 of bolts and brackets supporting the shelf above the vacuum pumps 25. The shelf 50 can be used to support cleaning supplies or other materials during operation of the cleaning apparatus, but more importantly, the shelf 50 protects the vacuum pumps 25, mufflers 26 and the vacuum ports 27 from damage should some object fall onto the top of the cleaning apparatus 10.

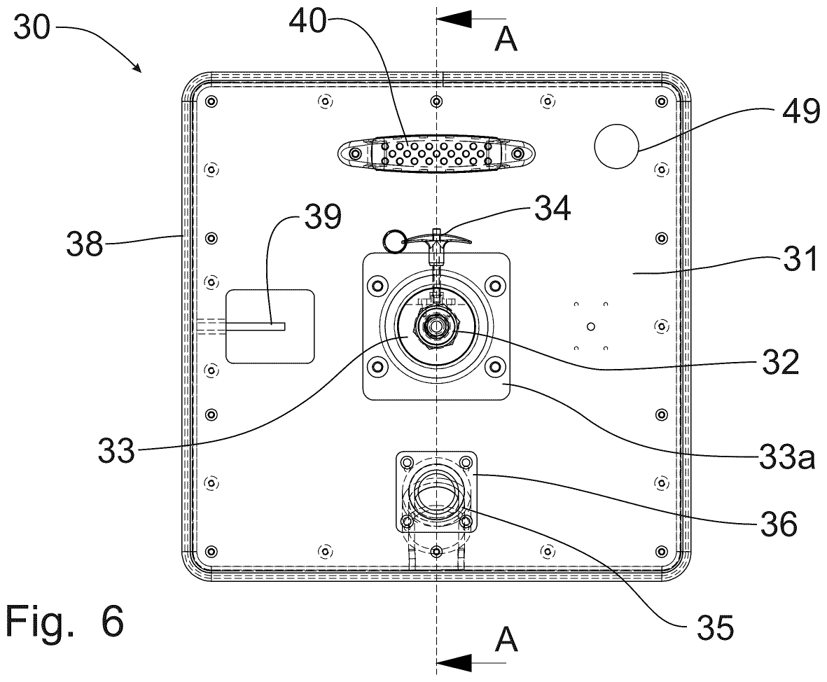

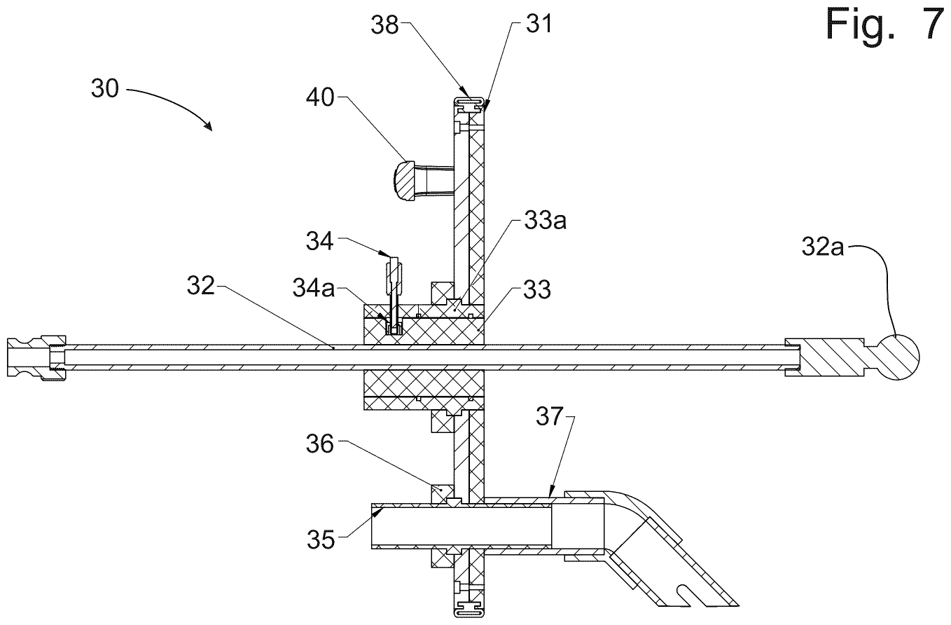

A door assembly 30 is best seen in FIGS. 6 and 7. The door assembly 30 is schematically shown as being compatible with a Getinge Model 433 or Model 533 sterilizer. The size and shape of the door panel 31 of the door assembly 30 depends on the model of sterilizer, or other device being cleaned and descaled. Accordingly the door panel 31 will have a different configuration, size and shape that conform to a door opening of the device being cleaned. Nevertheless, each door assembly 30 will have common components.

The door assembly 30 will have a wash wand 32 that is centrally supported on the door panel 31 by a wand slider collar 33 that is sealed with respect to the door panel 31, yet allows linear and rotational movement with respect to the door panel 31. The proximal end of the wash wand 32 is connected via a conduit (not shown) to the fluid output line 21, while the distal end of said wash wand 32 is formed with a rotating spray ball 32a that spins to disperse fluid throughout the interior of the sterilizer in a 360 degree pattern. A release pin 34 received within a pin lock bracket 34a retains the wand slider collar 33 within the shaft interface cylinder 33a formed as an integral part of the door panel 31. A vacuum tube 35 extends through the door panel 31 below the wash wand 32. The vacuum tube 35 is connected from the exterior portion of the vacuum tube 35 to the vacuum port 27 by a conduit (not shown). The vacuum tube 35 is secured in a sealed manner with respect to the door panel 31 by a vacuum hole plate 36. A vacuum pickup device 37 is affixed to an interior portion of the vacuum tube 35 and angled downwardly to be positioned proximate to the floor of the sterilizer (not shown) being cleaned and descaled.

Extending around the perimeter of the door panel 31 is an inflatable seal 38 to which is operatively connected a low pressure air inlet port 39. The air inlet port 39 is connected to the low pressure air chuck 24 by an air conduit (not shown) to provide a source of air under pressure to inflate the seal 38 after the door assembly 20 is installed into the door opening of the sterilizer (not shown). The door assembly 30 also includes handle 40 affixed to the door panel 31 in order to facilitate the installation of the door assembly 30 to the sterilizer and the removal, as well. The high pressure air chuck 23 can be used at the end of the cleaning process by attaching a hose thereto to discharge air to clean out screw holes or orifices and drying the sterilizer in general. A vacuum relief 49 is also incorporated in the door panel 31 covered by a rubber gasket that can open inwardly toward the sterilizer to provide an air flow for the vacuum pumps 25.

In operation, the cleaning apparatus 10 is wheeled to the site of the device, such as a medical equipment sterilizer, to be cleaned and descaled. The front access door 45 is opened to withdraw two power cords that are hung on hooks under the control panel 20. These power cords are then plugged into electrical outlets, which are preferably on separate breaker circuits, to provide power to the washing unit 12. One power cord supplies power to the vacuum motors 25 and the air compressor 17, while the other cord supplies power to the fluid pump 18 and heating pad 15a mounted in tank 15c. Dual power cords 46 are preferable in case the available electrical outlets are limited to 15 amps of current.

The door assembly 30 is inserted into the door opening of the sterilizer and positioned with the inflatable seal 38 engaged with the perimeter of the door opening of the sterilizer. An air conduit (not shown) is connected between the low pressure air chuck 24 and the air inlet port 39 on the door panel 31. Once powered, the air compressor 17 can provide a flow of air to the inflatable seal 38 to seal the door panel 31 to the sterilizer Hoses and conduits (not shown) are connected between the vacuum port 27 and the vacuum tube 35 on the door panel 31, and between the fluid output line 21 and the external, proximal end of the wash wand 32. At this point, the cleaning and descaling operation is ready to commence.

First, the fluid pump 18 is activated, with the tank selector valve 19 positioned to draw chemical wash fluid from the tank 15c to start the flow of wash fluid to the wash wand 32. The vacuum motor 25 for the tank 15c holding the chemical wash fluid is then activated to draw air from the tank 15c, which in turn draws a vacuum on the vacuum port 27 and then through the conduit associated therewith on the vacuum tube 35 to draw wash fluid from internally of the sterilizer. Wash fluid being discharged through the wash wand 32 and applied to the interior walls of the sterilizer by the rotating spray ball 32a fall to the floor of the sterilizer and is withdrawn through the vacuum tube 35 to return to the tank 15c through the vacuum port 27. The wash wand 32 can be moved linearly through the door panel 31 by manually pushing or pulling on the wash wand 32 to apply wash fluid from the rotating spray ball 32a in a manner elected by the operator.

Once the wash cycle has been completed, the fluid pump is deactivated so that no further wash fluid is supplied to the wash wand 32. Meanwhile, the vacuum motor 25 continues to operate extracting all of the wash fluid from the sterilizer being cleaned. Once the wash fluid has been extracted from the sterilizer and returned to the tank 15, the vacuum motor 25 for the tank containing the wash fluid is turned off so that the conduit connected to the vacuum port 27 for the chemical wash fluid tank 15c can be switched to the vacuum port 27 for the rinse fluid tank 15r. Then, the previous sequence for the wash fluid cycle is repeated, except that the tank selector valve 19 is manually flipped to draw rinse fluid from the rinse fluid tank 15r. The fluid pump 18 directs rinse fluid into the wash wand 32 to be dispensed internally to the walls of the sterilizer by the rotating spray ball 32a. Then the vacuum motor 25 for the rinse fluid tank 15r is activated to start the extraction of the rinse fluid from the sterilizer and return to the tank 15r via the vacuum tube 35, conduit and vacuum port 27.

As with the wash cycle, the operator can move the wash wand 32 with respect to the door panel 31 to direct the rinse fluid as desired by the operator during the rinse cycle. Once adequate rinsing has been accomplished, the fluid pump 18 is deactivated and the vacuum motor 25 is continued in operation until all of the rinse fluid has been extracted from internally of the sterilizer. Once the vacuum motor 25 has been turned off, the air pressure to the inflatable seal can be terminated to allow the seal to deflate and enable the door assembly 30 to be removed from the sterilizer A hose connected to the high pressure air chuck 23 can then be utilized to blow out any remaining rinse water. The two-sided ball valve 22 at the fluid outlet port 21 can be turned to allow the fluid pump 18 to extract the wash fluid and rinse fluid, respectfully, from the tanks 15c, 15r, and drained from the washing unit 12 for appropriate disposal. Once the hoses and conduits have been disconnected and the power cords returned to the storage compartment behind the front door 45 onto hooks, the washing unit 12 and door assembly 30 can be moved to the next job site for continued operation.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. An apparatus for cleaning and descaling a sealable device, comprising:
a washing unit including:
multiple tanks for holding a supply of washing and rinsing fluids;
a fluid pump associated with said tanks to withdraw fluid therefrom, said fluid pump being operatively connected with a tank selector valve to fluid to be withdrawn from a selected one of said tanks, said fluid pump directing selected fluid through a fluid outlet port;
an air compressor having an air chuck;
a vacuum motor for each respective tank to extract air from inside the tank and create negative pressure within the respective tank;
a vacuum port open to each respective tank so that said negative pressure asserted in said respective tank is applied to the corresponding vacuum port; and
a door assembly including:
a door panel having an inflatable seal extending around a perimeter thereof, said inflatable seal being operatively associated with an air inlet port in flow communication with said air compressor to inflate selectively said inflatable seal;
a wash wand centrally position through said door panel, said wash wand being supported by a wand slider collar to permit movement of said wand rotationally and linearly relative to said door panel, said wash wand being in flow communication via a conduit to said fluid outlet port, said wash wand having a spray nozzle at a distal end thereof to disperse fluid within said device; and
a vacuum tube passing through said door panel and being in flow communication via a conduit with a selected said vacuum port on said washing unit to return fluid from within said device to a corresponding said tank.

2. The apparatus for cleaning and descaling a sealable device of claim 1 wherein said vacuum tube has attached thereto a vacuum pickup device to retrieve fluid from within said device.

3. The apparatus for cleaning and descaling a sealable device of claim 1 wherein said wash wand can be moved linearly within said device to position said spray nozzle as desired for proper operation.

4. The apparatus for cleaning and descaling a sealable device of claim 3 wherein said wand slider collar is secured within a shaft interface cylinder integrally formed into said door panel.

5. The apparatus for cleaning and descaling a sealable device of claim 4 wherein said wand slider collar is retained within said shaft interface cylinder by a release pin interengaging said shaft interface cylinder and said wand slider collar.

6. The apparatus for cleaning and descaling a sealable device of claim 3 wherein said spray wand is provided with a rotatable spray ball to dispense fluid supplied to the spray wand in a 360 degree pattern.

7. The apparatus for cleaning and descaling a sealable device of claim 1 wherein each vacuum motor is associated with a ball shutoff float that deactivates the corresponding vacuum motor when the fluid level within the corresponding tank exceeds a predetermined level.

8. The apparatus for cleaning and descaling a sealable device of claim 1 wherein said fluid outlet port is associated with a valve selectively positionable to pass fluid through said fluid outlet port to said wash wand or to direct said fluid to be drained from the corresponding said tank.

9. An apparatus for cleaning and descaling a sealable device, comprising:
a washing unit including:
multiple tanks for holding supplies of washing and rinsing fluids;
a fluid pump associated with said tanks to withdraw fluid therefrom, said fluid pump being operatively connected with a tank selector valve to select the fluid to be withdrawn said tanks, said fluid pump directing selected fluid through a fluid outlet port;
a vacuum motor for each respective tank to extract air from inside the corresponding tank and create negative pressure within the corresponding tank;
a vacuum port open to each respective tank so that said negative pressure asserted in said respective tank is applied to the corresponding vacuum port; and
a door assembly including:
a door panel having an inflatable seal extending around a perimeter thereof, said inflatable seal being operatively associated with an air inlet port in flow communication with said air compressor to inflate selectively said inflatable seal;
a wash wand centrally position through said door panel, said wash wand being supported by a wand slider collar to permit movement of said wand linearly relative to said door panel, said wash wand being in flow communication via a conduit to said fluid outlet port, said wash wand having a spray nozzle at a distal end thereof to disperse fluid within said device; and
a vacuum tube passing through said door panel and being in flow communication via a conduit with a selected said vacuum port on said washing unit to return fluid from within said device to a corresponding said tank.

10. The apparatus for cleaning and descaling a sealable device of claim 9 wherein said vacuum tube has attached thereto a vacuum pickup device to retrieve fluid from within said device.

11. The apparatus for cleaning and descaling a sealable device of claim 9 wherein said wash wand can be moved linearly within said device to position said spray nozzle as desired for proper operation.

12. The apparatus for cleaning and descaling a sealable device of claim 9 wherein said wand slider collar is secured within a shaft interface cylinder integrally formed into said door panel.

13. The apparatus for cleaning and descaling a sealable device of claim 12 wherein said wand slider collar is retained within said shaft interface cylinder by a release pin interengaging said shaft interface cylinder and said wand slider collar.

14. The apparatus for cleaning and descaling a sealable device of claim 11 wherein said spray wand is provided with a rotatable spray ball to dispense fluid supplied to the spray wand in a 360 degree pattern.

15. The apparatus for cleaning and descaling a sealable device of claim 9 wherein each vacuum motor is associated with a ball shutoff float that deactivates the corresponding vacuum motor when the fluid level within the corresponding tank exceeds a predetermined level.

16. The apparatus for cleaning and descaling a sealable device of claim 9 wherein said fluid outlet port is associated with a valve selectively positionable to pass fluid through said fluid outlet port to said wash wand or to direct said fluid to be drained from the corresponding said tank.

17. An apparatus for cleaning and descaling a sterilizer machine, comprising:
a washing unit having multiple tanks for holding respective supplies of washing and rinsing fluids, and a fluid pump associated with said multiple tanks to withdraw fluid from selective said tanks, each of said tanks including a vacuum motor create negative pressure within the corresponding tank, each said tank also having a vacuum port open to the corresponding said tank; and
a door assembly having a door panel with an inflatable seal extending around a perimeter thereof and a wash wand centrally position through said door panel, said wash wand being linearly movable relative to said door panel, said wash wand having a spray nozzle at a distal end thereof to disperse fluid within said sterilizer machine, said door assembly further having a vacuum tube passing through said door panel and being in flow communication with a selected said vacuum port on said washing unit to return fluid from within said device to the corresponding said tank.

18. The apparatus for cleaning and descaling a sterilizer machine of claim 17 wherein said spray nozzle is provided with a rotatable spray ball to dispense fluid supplied to the spray wand in a 360 degree pattern.

19. The apparatus for cleaning and descaling a sterilizer machine of claim 17 wherein said tanks are associated with a selector valve to determine which of said tanks fluid is to be withdrawn for application to said sterilizer machine, said fluid passing through a fluid outlet port into said wash wand.

20. The apparatus for cleaning and descaling a sterilizer machine of claim 19 wherein said fluid outlet port is selectable to direct said fluid to be drained from the corresponding said tank.
